(19) United States
(12) Patent Application Publication
(10) Pub. No.: US 2025/0235006 A1
(43) Pub. Date: Jul. 24, 2025

(54) CONVERTIBLE SOFA

(71) Applicant: Brinkley RV LLC, Goshen, IN (US)

(72) Inventors: Nathan Goldenberg, Granger, IN (US); Barry Wade Ousley, Syracuse, IN (US); Dominick Bilancio, Elkhart, IN (US)

(73) Assignee: Brinkley RV LLC, Goshen, IN (US)

(21) Appl. No.: 19/032,353

(22) Filed: Jan. 20, 2025

Related U.S. Application Data
(60) Provisional application No. 63/622,635, filed on Jan. 19, 2024.

(51) Int. Cl. A47C 17/22

(52) U.S. Cl. CPC A47C 17/22

(57) ABSTRACT

A convertible sofa can move between a storage/transport position and a fully expanded position. The sofa has a center section that is connected between left and right sections with actuators. The actuators are connected to sensors and a controller to move the sofa between its positions and prevent movement if components are not properly positioned. The center section has foldable seat backs that can fit under the left and right sections when the actuators are retracted and be hinged to be moved into a raised position to become backrests when the actuators are extended. The controller is connected to a slide-out to prevent the slide-out from retracting if the sofa is not in the storage/transport position.

### CROSS REFERENCE TO RELATED APPLICATIONS

This application claims the benefit of Provisional Application Ser. No. 63/622,635, filed Jan. 22, 2024, the disclosure of which is incorporated by reference.

### BACKGROUND OF THE INVENTION

The present disclosure relates to sofas, chairs, and other seating areas that are used with recreational vehicles, mobile living quarters, or other living areas where reconfiguration is desired or floor space is at a premium. Other devices that attempt to solve this problem are either limited in their flexibility and ability to be configured or require folding or flipping sections over to reconfigure. Others are complicated or allow the user to damage the device or living space through mechanical interference or lack of interlocks. Therefore, an improved flexible seating area is needed.

### SUMMARY OF THE INVENTION

The present disclosure describes a configurable seating area with left, center, and right sections. The center section has at least one seat back section that is pivotable between a raised and a lowered position. In the lowered position, the seat back section overlays the frame of the center section. The left and right sections are each individually coupled to the center section through linear actuators that translate the left and/or right sections between an expanded position and a closed position. In the closed position, leading edges of hinged seats of the left and right sections overlap, and the center section is completely received by cavities in the left and right sections. To move the seating area to the closed position, all seat backs in the center section must first be pivoted to the lowered position. The seating area contains sensors to interlock the actuators and/or slide-out room from movement unless the conditions are met for safe movement.

### BRIEF DESCRIPTION OF THE DRAWINGS

FIG. 1 is a front isometric view of the seating area in the fully expanded position;

FIG. 2 is a front isometric view of the seating area in FIG. 1 in the partially expanded position;

FIG. 3 is a front isometric view of the seating area in FIG. 1 in the sleeping position;

FIG. 4 is a front isometric view of the seating area in FIG. 1 in the fully closed position;

FIG. 5 is a partially exploded view of the seating area in FIG. 1;

FIG. 6 is a front section view 6-6 of the seating area in FIG. 1;

FIG. 7 is a front section view 7-7 of the seating area in FIG. 2;

FIG. 8 is a front section view 8-8 of the seating area in FIG. 3;

FIG. 9 is a front section view 9-9 of the seating area in FIG. 4 as installed in a slide-out with the slide-out in the retracted position;

FIG. 10 is a front section view 6-6 of the seating area in FIG. 9 with cushions installed in the fully expanded position and the slide-out in the extended position; and

FIG. 11 is a diagram of the control system connections to actuators and sensors.

### DESCRIPTION OF THE PREFERRED EMBODIMENT

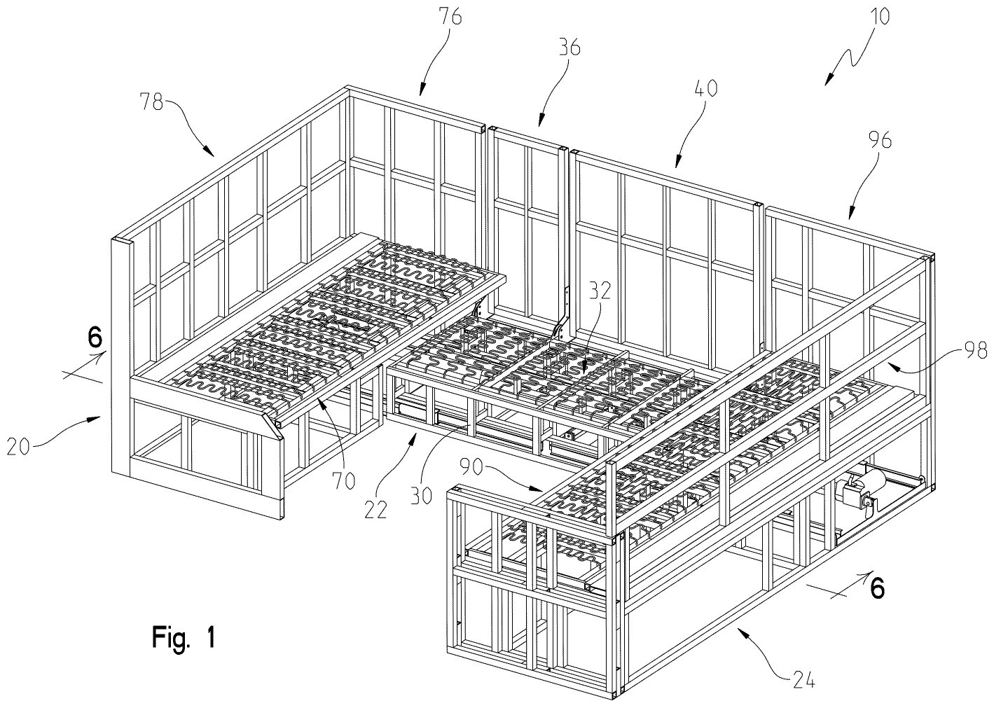

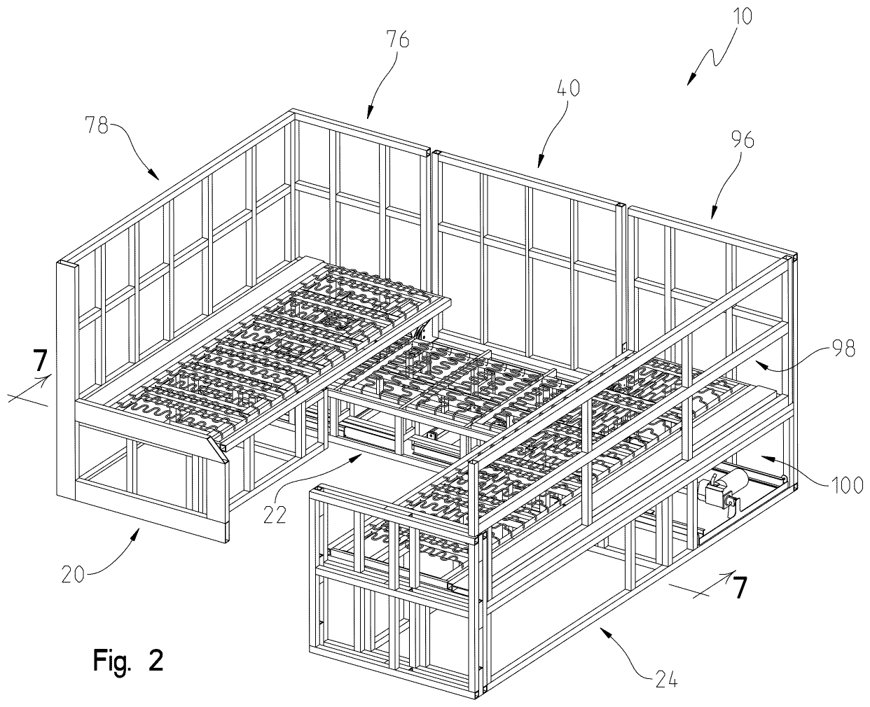

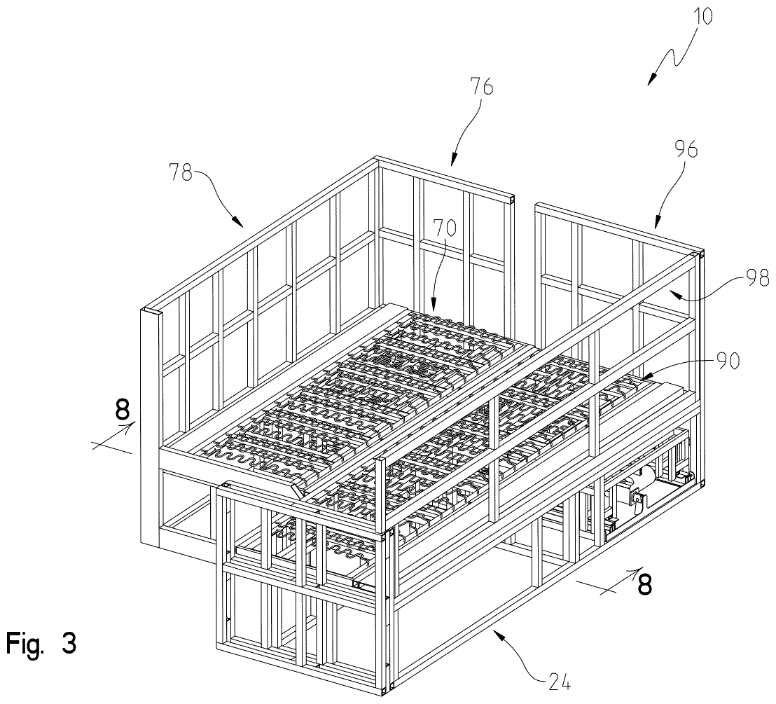

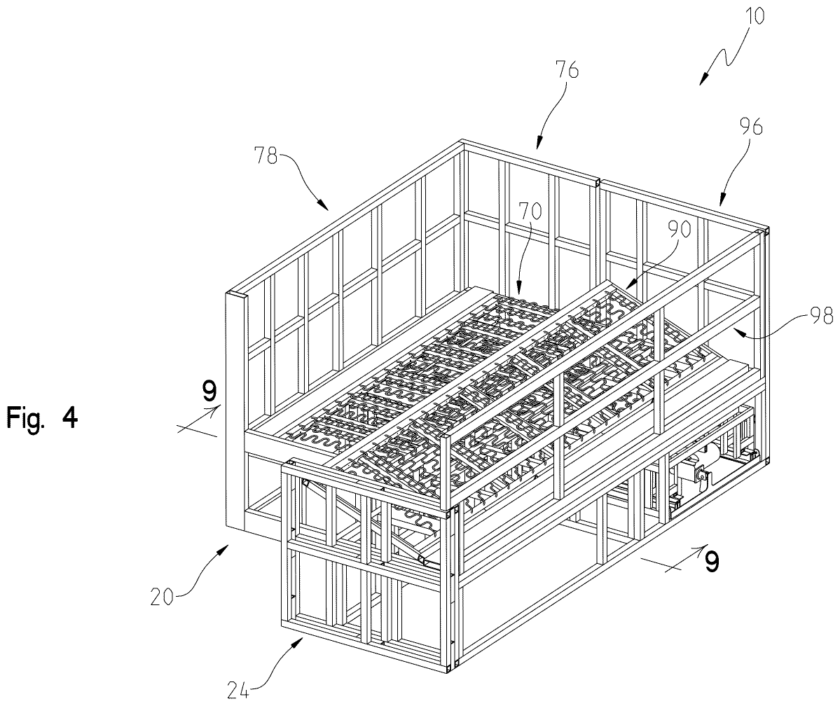

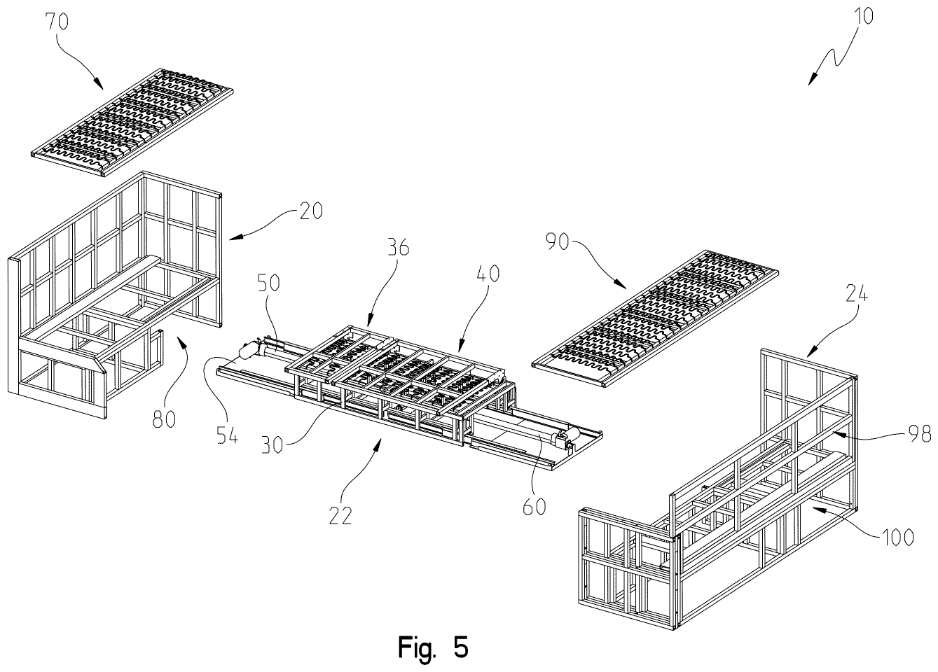

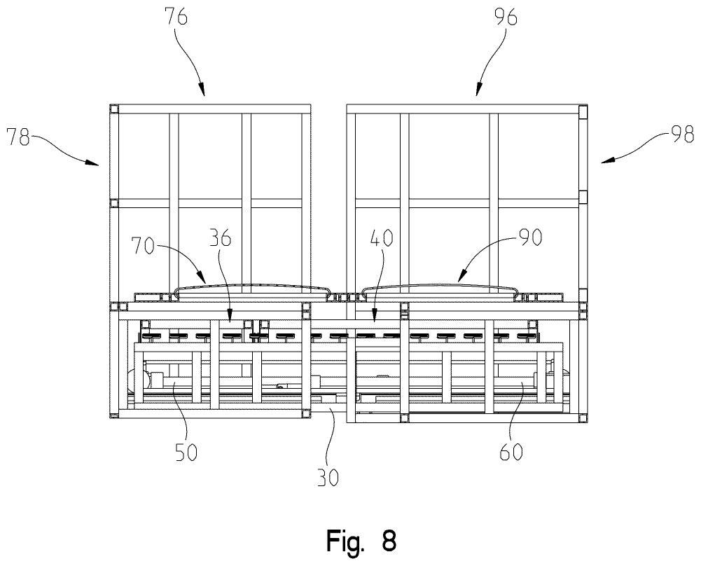

A convertible sofa or seating area 10 is shown in FIGS. 1-10 and comprises three main sections, a left side 20, a center section 22, and a right side 24. The center section 22 is connected to the left side 20 and right side 24. As will be described in greater detail below, the seating area 10 is configurable between a fully expanded position (shown in FIG. 1), a partially expanded position (shown in FIG. 2), a sleeping position (shown in FIG. 3), and a fully closed position (shown in FIG. 4). The designations of left, right, and center are merely for reference and are not intended to limit the disclosures herein to any specific configuration.

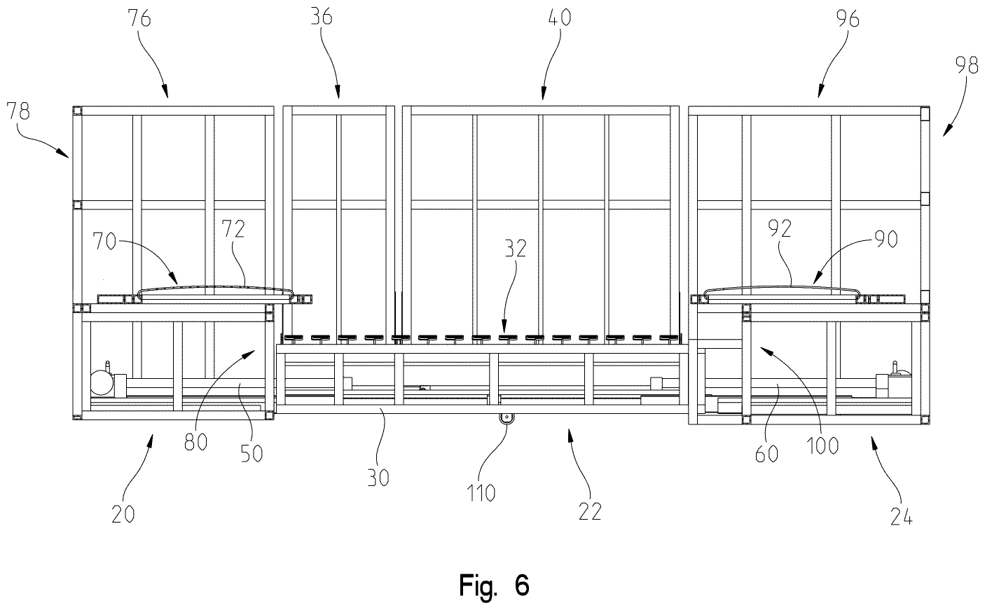

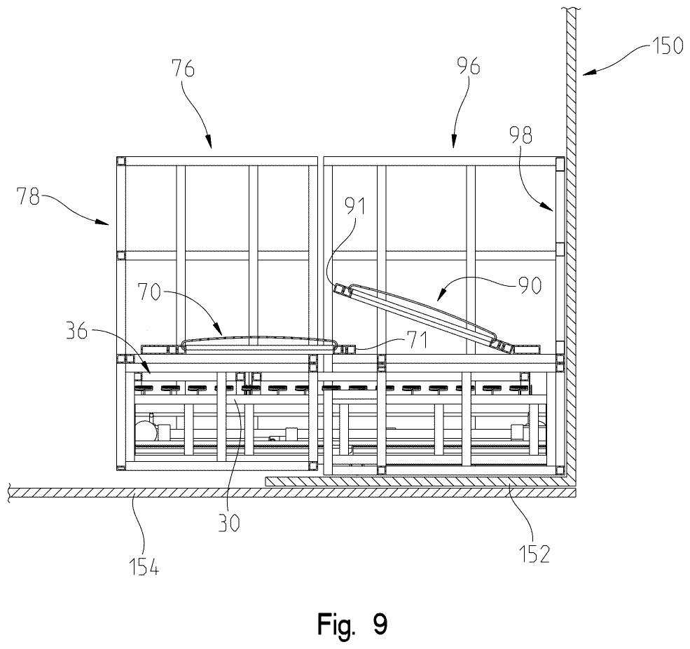

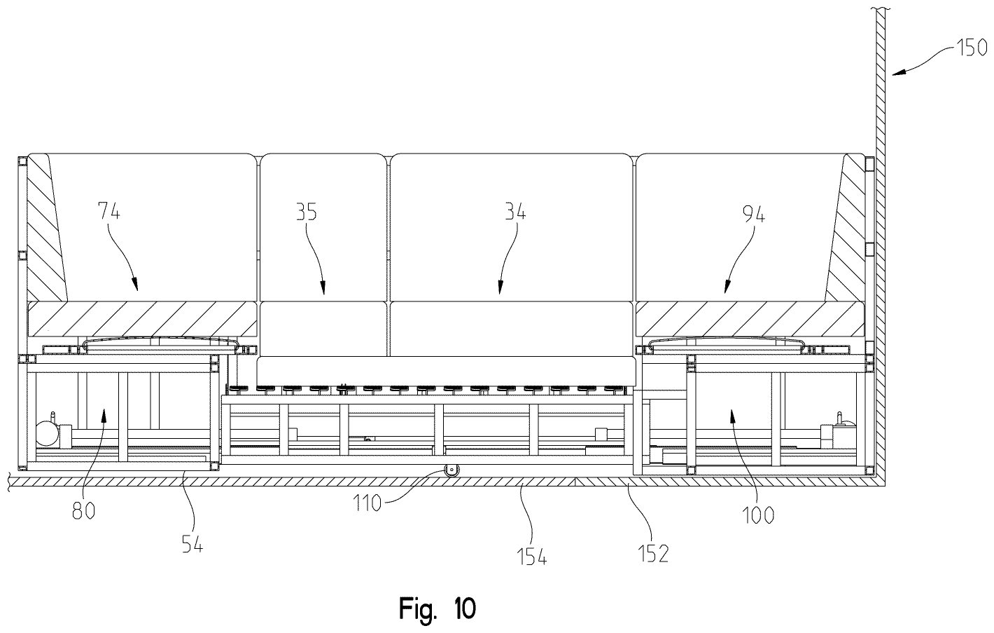

The center section 22 has a base frame 30 with a series of seat springs forming a seat bottom 32 that support center cushions 34, 35 (shown in FIG. 10). The center cushions 34, 35 are shown as relatively large individual cushions but it is contemplated that they are an assembly of smaller cushions that are secured or held together. The center section 22 has a first seat back section 36 that is hinged 38 where it meets the base frame 30 and can pivot between a raised and lowered position. Adjacent to the first seat back section 36 is a second seat back section 40 that is also hinged 42 where it meets the base frame 30. The second seat back section 40 can pivot between a raised and lowered position. In the embodiment shown herein, both seat back sections 36, 40 pivot about a seat back axis 44. The seat bottom 32 does not raise up or lower with respect to the base frame 30 when the back sections 36, 40 are moved. When the seat back sections 36, 40 are in the lowered position, they overlay the seat bottom 32 in the center section 22. Affixed to the base frame 30 is a left linear actuator 50 that can move between an extended position shown in FIG. 6 and a contracted position shown in FIG. 9. At the opposite end, the left linear actuator 50 is affixed to a left sliding portion 52. The left sliding portion 52 has a gliding pan 54 with a smooth bottom surface that allows movement of the sliding portion 52 over the floor, however it is contemplated that the left side 20 has rollers, wheels, or equivalent device that allows movement over a floor surface. The left sliding portion 52 is also connected to the base frame 30 through a pair of linear slides 56, 58. When the left linear actuator 50 is fully contracted, the left sliding portion 52 is located within the base frame 30, as shown in FIGS. 4 and 9. When the left linear actuator 50 is fully extended, the left sliding portion 52 is located outside of the base frame 30, shown in FIGS. 1 and 6. A right linear actuator 60 is also affixed to the base frame 30 and can move between an extended position shown in FIGS. 1 and 6 and a contracted position shown in FIGS. 4 and 9. At the opposite end, the right linear actuator 60 is affixed to a right sliding portion 62. The right sliding portion 62 has a gliding pan with a smooth bottom surface that allows movement of the sliding portion 62 over the floor. The right sliding portion 62 is also connected to the base frame 30 through a pair of linear slides 66, 68. When the right linear actuator 60 is fully contracted, the right sliding portion 62 is located within the base frame 30, as shown in FIGS. 4 and 9. When the right linear actuator 60 is fully extended, the right sliding portion 62 is located outside of the base frame 30, shown in FIGS. 1 and 6. The actuators 50, 60 can include position feedback sensors 51, 61 that interface with a controller 200. The controller 200 monitors the status of switches, position of the actuators, and any user input to control the movement of the actuators 50, 60 and provide interlock capability to slide-out rooms (to prevent the slide-outs from retracting if the sofa 10 is not in the fully closed position). The position feedback sensors 51, 61 are also utilized by the controller to move the actuators (and therefore the sofa) to setpoint positions, such as the positions shown in FIGS. 1-4 and 6-9

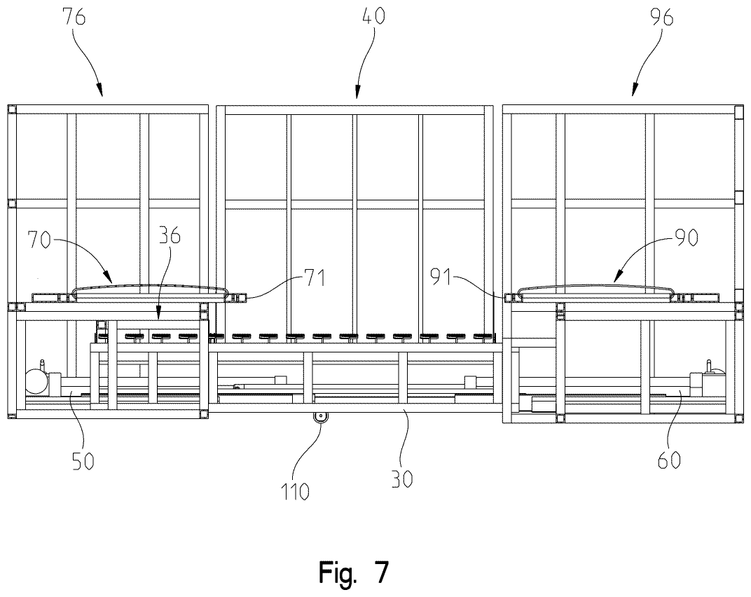

The left side 20 is affixed to the left sliding portion 52 and therefore moves with it when the left actuator 50 moves between the extended and contracted positions. The left side 20 has a seat bottom 70 with a series of seat springs 72 that support a left side cushion 74 (shown in FIG. 10). The seat bottom 70 can be removed or pivoted upwards by lifting on the front to access storage areas or to allow clearance for lowering the seat back section 36. The left side 20 has a back frame 76 and a side frame 78 that are fixed and extend above the seat bottom 70. The back and side frames 76, 78 support back cushions. The left side 20 has a cavity 80 that receives a portion of the center section 22 when the left actuator 50 is moved towards the contracted position from the fully extended position. The cavity 80 includes sufficient clearance for the first seat back 36 and part of the second seat back 40, shown in FIGS. 7-9.

The right side 24 is affixed to the right sliding portion 62 and moves with it when the right actuator 60 moves between the extended and contracted positions. The right side 24 has a hinged seat 90 with a series of seat springs 92 that support a right side cushion 94 (shown in FIG. 10). The hinged seat 90 can be pivoted between a use position as shown in FIGS. 1-3 and a lifted position as shown in FIG. 4. The hinged seat 90 is pivoted to the lifted position by lifting on the front to access any storage areas or allowing clearance when the seating area 10 is in the fully closed position, shown in FIG. 9. The hinged seat 90 may also include gas struts or other counterbalancing devices to allow it to remain in the lifted position. The right side 24 has a back frame 96 and side frame 98 that are fixed and extend above the hinged seat 90. The back and side frames 96, 98 support back cushions. The right side 24 has a cavity 100 that receives a portion of the center section 22 when the right actuator 60 is moved towards the contracted position from the fully extended position. The cavity 100 includes sufficient clearance for the part of the second seat back 40, as shown in FIG. 9. As can be seen in FIGS. 1-4 and 6-10, the center seat bottom 32 remains at a lower elevation compared to the seat bottoms 70, 90. This allows them to be received by the cavities 80, 100 but does require that bottom cushions 34, 35 are thicker so that the seating surface matches the elevation of the bottom cushions 74, 94 that are used for the left and right sections. This is visible in FIG. 10.

When the first and/or second seat back sections 36, 40 are in the raised position, they are vertical and coplanar with the back frames 76, 96 and would collide if the seat back sections 36, 40 are left in the raised position when the actuators 50, 60 are retracted from the extended position. Therefore, the second seat back section 40 must be pivoted to the lowered position before moving the right side 24. The first seat back section 36 must be pivoted to the lowered position before moving the left side 20. If the left side 20 is further retracted from the position shown in FIGS. 2 and 7, the second seat back section 40 would also need to be pivoted to the lowered position. To prevent the user from colliding the seat back sections 36, 40 to back frames 76, 96, sensors may be implemented in the seat back sections 36, 40, center seat bottom 32, or other parts of the center section 22 that communicate with the controller to restrict the actuators 50, 60 from moving to certain positions unless the appropriate seat back section is in its lowered position. There may also be sensors or switches in the seat bottoms 70, 90 or sides 20, 24 that sense if the seat is in the use or lifted position. One example of a hinged seat being lifted is shown in FIGS. 4 and 9 with hinged seat 90.

The seating area 10 is used with mobile living quarters, typically in combination with a slide-out room 150. Slide-out rooms are well-known in the mobile living quarters art, so the details and operation of them are only discussed to the extent that relate to the seating area 10. The slide-out room 150 is moveable between a retracted and an extended position. The extended position is for when the vehicle is parked and in use; the retracted position is used during travel and storage. For the purposes of this disclosure, there are two main types of slide-out rooms: a flush floor design or stepped floor design. In the stepped floor design, the slide-out only moves in the horizontal direction. To account for the thickness of the slide floor and related components in the stepped floor design, the slide-out floor remains at a higher elevation than the rest of the flooring irrespective of the position of the slide-out. In the flush floor design, the slide-out lowers or drops down as it reaches the extended position. This allows for the slide floor 152 to be coplanar with the fixed floor 154 when the slide-out is fully extended, shown in FIG. 10. As the slide-out is retracted, the slide-out structure raises up so that the slide floor can overlay the rest of the floor, shown in FIG. 9. The seating area 10 must be fully closed position so that the left side 20 is at least partially supported by the slide floor 152 when the slide-out room 150 is retracted. With the slide-out in the extended position, the seating area 10 can be moved to any of the positions described herein. In contrast, when the slide-out is in the retracted position, the seating area 10 is in the fully closed position. If the sensors detect that the seating area 10 is not in the fully closed position, the slide-out room is locked out from moving to the retracted position. In the embodiment shown herein, the right side 24 is attached to the slide-out room with the side frame 98 abutting the outside wall of the slide-out room. With the right side 24 attached to the structure, movement of the right actuator 60 causes the center section 22 and left side 20 to move with respect to the floor. The center section 22 is supported by a roller 110 and the left side 20 is supported by the gliding pan 54, wheels, or rollers which allows movement.

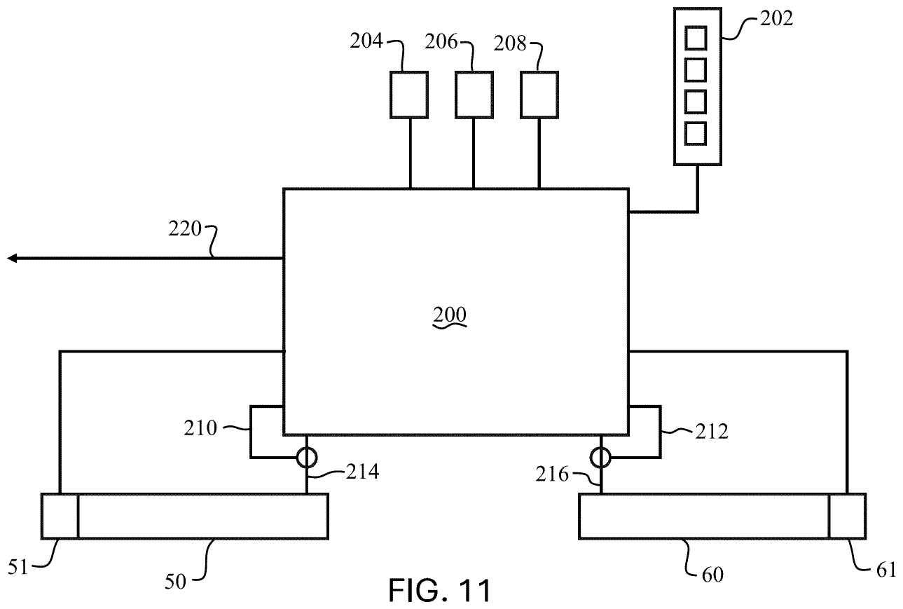

The controller 200 is shown graphically in FIG. 11 and uses inputs to control movement and position of the actuators 50, 60. In addition, the controller 200 may interface with mobile living quarters, particularly the slide-out mechanism, to prevent movement that could damage the seating area 10, mobile living quarters, or both. Inputs to the controller 200 include a keypad 202, actuator position sensors 51, 61, seat back position sensors 204, 206, seat bottom position sensors 208, and any other switch or sensor necessary for interfacing with the slide-out mechanism. The sensors 204, 206, 208 can be contacting mechanical switches, magnetic switches, or other technology that can send a signal based on the presence, proximity, or absence of another object. Optional current feedback sensors 210, 212 can monitor power going to the actuator(s) to determine if there is binding in the mechanism or an obstruction. Outputs from the controller 200 include power outputs for the actuators 50, 60, and an interlock output 220 for the slide-out mechanism. Other connections to the controller 200 could include manual override, display outputs for a user interface, troubleshooting, or to communicate with other devices for remote operation. Upon startup, the controller 200 reads the position of the actuator position sensors 51, 61 and determines where the seating area is (fully closed, sleeping, partially expanded, fully expanded, or somewhere in between). Based on the position, the slide-out interlock may be engaged, preventing retraction, extension, or both. The user actuates the buttons on the keypad 202 to move the seating area 10 between its predetermined positions. In the embodiment of the controller 200 shown herein, the user holds the desired button on the keypad 202 to start movement. Provided the user has moved any of the seat bottoms or seat backs to the appropriate position, the controller will begin moving the actuator(s) towards the desired position. As the position feedback sensors 51, 61 reach the value expected by the controller for the desired position, the controller stops the actuators once they've reached their position. If the user desires to move the seating area 10 further (and has the seat bottoms or seat backs in their expected positions), the user again presses buttons on the keypad 202 to move the seating area further. If the seat bottoms or seat backs are not in their respective positions for the desired movement, the controller may not move the actuators, send an error signal, or both. The controller 200 stores the positions and/or the corresponding position feedback sensor values so the controller can stop the actuators at positions based on the button pressed by the user with the fully expanded, partially expanded, sleeping, or fully closed positions.

Movement of the seating area 10 between the fully closed and fully expanded positions will now be described in detail. With the slide-out in the retracted position, the seating area 10 is in the fully closed position. Depending on the amount of floor space available when the slide-out is in the retracted position, it may be possible to move the seating area 10 to the sleeping position. The sleeping position is defined by the actuators 50, 60 extending enough to allow the leading edges 71, 91 of the seat bottoms 70, 90 to abut each other. This allows the seat bottoms 70, 90 and cushions 74, 94 to form a flat surface for sleeping. To move the seating area 10 to the partially or fully expanded positions, the slide-out room must be moved to the extended position. It is contemplated that the actuators 50, 60 are interlocked from extending unless the slide-out room is in the extended position. Once the slide-out is extended, the seating area 10 can be moved to the partially expanded position, shown in FIG. 7. Once the actuators 50, 60 have extended enough to free the second seat back section 40, it can be pivoted from the lowered position, shown in FIG. 2 to the raised position, shown in FIG. 1. This may involve moving one or both of the seat bottoms 70, 90 to clear the second seat back section 40 for pivoting. If the user desires to keep the seating area 10 in the partially expanded position, they install the center cushion 34 and any back cushions that cover the second seat back section 40. To move the seating area 10 to the fully expanded position, the actuators 50, 60 are moved to their fully extended position, which allows the first seat back section 36 to be pivoted to the raised position. At this time, the center cushion 35 can be reinstalled, along with any cushions that cover the first seat back section 36. Movement of the seating area 10 to the partially expanded, sleeping, or fully closed position is the reverse of the aforementioned steps, with the sensors and interlocks preventing the user from moving the actuators 50, 60 until the seat back sections 36, 40 are pivoted to their lowered positions. Interlocks with either sensors and/or actuators can prevent movement of the slide-out to the retracted position unless the seating area 10 is in the fully closed position. As the seating area 10 moves from the sleeping position to the fully closed position, a ramped surface (or the user) causes the hinged seat 90 to lift up at the leading edge 91 and overlay the seat bottom 70, shown in FIGS. 4 and 9.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A configurable sofa comprising:
a center section having a first seat back and a base frame with a seat bottom, said first seat back is pivotable between a lowered and a raised position, when said first seat back is in said lowered position, said first seat back overlays a portion of said center seat bottom;
a left section having a seat back and a seat bottom, said left section is coupled to said center section with a first actuator, said left section is moveable with respect to said center section between an extended position and a contracted position, in said contracted position, a portion of said center section is received by a cavity under said seat bottom in said left section;
a right section having a seat back facing said seat back of said left section, said right section having a hinged seat bottom, said hinged seat bottom is pivotable between a use position and a lifted position, said right section coupled to said center section with a second actuator, said right section is moveable with respect to said center section between an extended position and a contracted position, in said contracted position, another portion of said center section is received by a cavity under said hinged seat bottom in said right section; and
when said first seat back is in said lowered position, said left and right sections are moveable to said contracted positions and said center section is located in said cavities of said left and right sections.

2. The configurable sofa in claim 1, said sofa is moveable between a stowed position, a sleeping position, and a partially expanded position, in said stowed position, said hinged seat bottom of said right section is in said lifted position and overlaps said seat bottom of said left section, in said sleeping position, said hinged seat bottom of said right section is in said use position and abuts said seat bottom of said left section, in said partially expanded position, said first seat back of said center section is pivotable to said raised position.

3. The configurable sofa in claim 2, wherein said sofa is moveable to a fully expanded position, said center section having a second seat back adjacent said first seat back, said second seat back is pivotable between a lowered and a raised position, when said second seat back is in said lowered position, said second seat back overlays another portion of said center seat bottom, when said sofa is in said fully expanded position, said first and second seat backs are pivotable to said raised position.

4. The configurable sofa in claim 1, wherein said first actuator has a position feedback sensor and said second actuator has a position feedback sensor, further comprising a controller in communication with said position feedback sensors.

5. The configurable sofa in claim 4, further comprising a sensor to detect said raised or lowered position of said first seat back, said sensor in communication with said controller, said right section having a sensor to detect said use or lifted position of said hinged seat bottom, said sensors are in communication with said controller, said left and right sections are moveable to said contracted positions when said hinged seat bottom is in said raised position.

6. The configurable sofa in claim 4, further comprising mobile living quarters having a slide-out, said slide-out is moveable between an extended position and a retracted position, said controller in communication with said slide-out, when said left or right section is moved from said contracted position, said slide-out is held in said extended position.

7. The configurable sofa in claim 6, wherein said left or right section is fixed with respect to said slide-out, the other of said left or right section is moveable with respect to said slide-out.

8. The configurable sofa in claim 6, wherein said mobile living quarters having a fixed floor, said slide-out having a slide floor, when said slide-out is in said extended position, said slide floor is coplanar with said fixed floor, when said slide-out is in said retracted position, said slide floor overlays a portion of said fixed floor and a portion of said configurable sofa extends unsupported beyond an edge of said slide floor.

9. A configurable sofa comprising:
a center section having a seat back and a base frame with a seat bottom, said seat back is pivotable between a lowered and a raised position, when said seat back is in said lowered position, said seat back overlays a portion of said center seat bottom;
a left section having a seat back and a seat bottom, said left section is coupled to said center section with a first actuator, said left section is moveable between an extended position and a contracted position, in said contracted position, a portion of said center section is received by a cavity under said seat bottom in said left section;
a right section having a seat back and a seat bottom, said right section coupled to said center section with a second actuator, said right section is moveable between an extended position and a contracted position, in said contracted position, another portion of said center section is received by a cavity under said seat bottom in said right section;
said seat bottom of said left or right section is a hinged seat bottom, said hinged seat bottom is pivotable between a use position and a lifted position;
when said left and right sections are in said contracted position, said center section is completely located in said cavities of said left and right sections; and
said sofa is moveable between a stowed position, a sleeping position, and a partially expanded position, in said stowed position, said hinged seat bottom is in said lifted position and overlaps another of said seat bottoms, in said sleeping position, said seat bottom of said right section abuts said seat bottom of said left section, in said partially expanded position, said seat bottoms of said left and right sections are spaced from each other and said seat back of said center section is pivotable to said raised position.

10. The configurable sofa in claim 9, wherein said first actuator has a position sensor and said second actuator has a position sensor, further comprising a controller in communication with said position sensors to move said sofa to said stowed, sleeping, and partially expanded positions.

11. The configurable sofa in claim 10, further comprising mobile living quarters having a slide-out, said slide-out moveable between an extended position and a retracted position, said controller in communication with said slide-out, when said sofa is moved from said stowed position, said slide-out is held in said extended position.

12. The configurable sofa in claim 9, wherein said sofa is moveable to a fully expanded position, said center section having a second seat back pivotable between a lowered and a raised position, when said second seat back is in said lowered position, said second seat back overlays another portion of said center seat bottom, when said sofa is in said fully expanded position, said first and second seat backs are pivotable to said raised position.

13. The configurable sofa in claim 9, wherein said first actuator has a position sensor and said second actuator has a position sensor, further comprising a controller in communication with said position sensors.

14. The configurable sofa in claim 13, further comprising a sensor in said center section to detect said raised or lowered position of said seat back, said sensor in communication with said controller, said left or right section having a sensor to detect said position of said hinged seat bottom.

15. A configurable sofa comprising:
a center section having a first seat back and a base frame with a seat bottom, said first seat back is pivotable between a lowered and a raised position, when said first seat back is in said lowered position, said first seat back overlays a portion of said center seat bottom;
a left section having a seat back and a seat bottom, said left section is coupled to said center section with a first actuator, said left section is moveable with respect to said center section between an extended position and a contracted position, in said contracted position, a portion of said center section is received by a cavity under said seat bottom in said left section;
a right section having a seat bottom and seat back facing said seat back of said left section, said right section coupled to said center section with a second actuator, said right section is moveable with respect to said center section between an extended position and a contracted position, in said contracted position, another portion of said center section is received by a cavity under said seat bottom in said right section;
said seat bottom of said left or right section is a hinged seat bottom, said hinged seat bottom is pivotable between a use position and a lifted position;
said first and second actuators each having a position feedback sensor, said center section having a sensor to detect said raised or lowered position of said first seat back;
when said first seat back is in said lowered position, said left and right sections are moveable to said contracted positions and said center section is located in said cavities of said left and right sections; and
a controller in communication with said first and second actuators, said position feedback sensors, and said sensor.

16. The configurable sofa in claim 15, said sofa is moveable between a stowed position, a sleeping position, and a partially expanded position, in said stowed position, said hinged seat bottom of said left or right section is in said lifted position and overlaps the other of said left or right seat bottom, in said sleeping position, said hinged seat bottom is in said use position and abuts the other of said left or right seat bottom, in said partially expanded position, said first seat back of said center section is pivotable to said raised position.

17. The configurable sofa in claim 16, wherein said controller stores values for said position feedback sensors to move said sofa to said stowed, sleeping, and partially expanded positions.

18. The configurable sofa in claim 16, further comprising mobile living quarters having a slide-out, said slide-out is moveable between an extended position and a retracted position, said controller is in communication with said slide-out, when said left or right section is moved from said contracted position, said slide-out is held in said extended position.

19. The configurable sofa in claim 18, wherein said left or right section is fixed with respect to said slide-out, the other of said left or right section is moveable with respect to said slide-out.

20. The configurable sofa in claim 18, wherein said mobile living quarters having a fixed floor, said slide-out having a slide floor, when said slide-out is in said extended position, said slide floor is coplanar with said fixed floor, when said slide-out is in said retracted position, said slide floor overlays a portion of said fixed floor and a portion of said configurable sofa extends unsupported beyond an edge of said slide floor.
